(19) United States
(12) Patent Application Publication
(10) Pub. No.: US 2023/0372183 A1
(43) Pub. Date: Nov. 23, 2023

(54) REHABILITATION APPARATUS FOR WRIST AND FOREARM THERAPY

(71) Applicant: TECHNISCHE UNIVERSITÄT HAMBURG, Hamburg (DE)

(72) Inventors: Alireza ABBASIMOSHAEI, Hamburg (DE); Thorsten A. KERN, Hamburg (DE)

(21) Appl. No.: 18/024,734

(22) PCT Filed: Aug. 18, 2021
(86) PCT No.: PCT/EP2021/072910

§ 371 Date: Mar. 3, 2023

(30) Foreign Application Priority Data
Sep. 4, 2020 (LU) LU102030

(51) Int. Cl. A61H 1/02

(52) U.S. Cl. CPC A61H 1/0285; A61H 2201/0176; A61H 2201/1215; A61H 2201/1635; A61H 2201/1685; A61H 2201/5061; A61H 2201/5064; A61H 2201/5079

(57) ABSTRACT

A rehabilitation apparatus for wrist and forearm therapy comprising an adjustable armrest, a motor, and a rotatable base having a plurality of sockets for engaging a plurality of handles for different types of therapy, wherein the motor is configured to move the rotatable base.

### TECHNICAL FIELD

The present invention relates to a rehabilitation apparatus for wrist and forearm therapy. The present invention can for example find an application in the context of therapy after a hand and/or wrist injury, in particular at home and thus without the need of professional guidance during the therapy or at a hospital or the like, in this case also reducing the amount of professional guidance.

### TECHNICAL BACKGROUND

Among all types of injuries, hand injuries are the most common ones. For example, hand and wrist injuries have a rate of 3% to 9% of all sports injuries. Moreover, the hand is the most important organ in interaction with the environment. Repetitive hand rehabilitation techniques are often used to regain hand activities. Hand rehabilitation apparatuses and specifically portable and modular, that is, with the ability to change the rehabilitation tasks by adding and removing different parts, rehabilitation apparatuses can help physiotherapists and patients do the exercises.

An obstacle for this kind of rehabilitation is that the patients are often inadequately treated or rehabilitated because they disregard what they perceive as inconsequential symptoms, and they do not complete the rehabilitation process because of the long time required. Home rehabilitation can make this procedure easier.

Fractures can lead to complication and stiffness of phalanges. Some of the common injuries such as intra-articular adhesions, extra-articular contractures, extensor and flexor lacerations, burns, crush injuries, and strokes can be treated with passive motions and active resistance exercises.

Conventional rehabilitation procedures such as acupuncture or electromagnetic wave aimed to increase blood circulation and prevent muscle disuse atrophy by stimulating the damaged muscle. But they usually take a lot of time to lead to a positive impact and they need professional help. Different parameters affect the outcome of the exercises, such as onset, duration, intensity and task orientation of the training, patient's health condition, attention, and effort. During assisting the patient, therapist suffers a high load due to repetitions of coordinated activities. Further, patients prefer to do the exercises in a shorter time and thus the traditional rehabilitation decreases number of under-rehabilitation patients because it needs a great deal of therapist's Therapists can help patients to perform different exercises. So, to provide the services to this wide range of patients, much more sufficient therapists are needed. It is hard to measure the amount of the flexion in the conventional method. But a rehabilitation apparatus can increase the amount of flexion step by step. Furthermore, Lack of therapists and different level of them are big problems in this area.

Due to the above, to decrease the disadvantages of conventional rehabilitation, there is an interest in using a new method and equipment such as rehabilitation robotics.

Rehabilitation apparatuses provide tasks to help patients to reach the desired path of the organ. Moreover, patients can modify the rehabilitation exercises according to their condition and improvements.

Up to now, there is no system known that can rehabilitate all three DOFs of wrist or they are complicated. Most of them were so expensive or have other problems that prevent them to be used as a home rehabilitation apparatus. Rehabilitation apparatuses should be affordable, have an appropriate design and portable to enable more patients to use them even at home. Compactness of multi DOF apparatuses would be a great point in these systems and makes a high demand for them.

There are three modes of movements for wrist rehabilitation: The passive mode in which the therapist moves the patients' hand and guides them through a set of motions. In active mode, patients do the trainings and move their hand without the help of the therapist. Active resistance mode is the exercises in them the patients move the hand and an external force inserts in the reverse direction to their hands. In traditional therapy, this mode has been done by springs or a force applied by the therapist or with a rubber ball.

Wrist therapy should provide active and passive exercises. Firstly, the active range of motion is allowed. The Patient should stretch the wrist slowly to improve the gliding of the APL and EPB tendons in the first tunnel. After 1 to 2 weeks, passive rehabilitation starts. It includes extension and flexion exercises. When the pain decreased, the strengthening could be done in the bigger angle. When the range of motion improves, the active resistance exercises begin. The time necessary for recovery is related to the immobilization length and deal of injury. Wrist rehabilitation consists of flexion-extension and ulnar-radial movements. Forearm rehabilitation consists of pronation and supination.

### SUMMARY

The above problems are solved by the subject-matter of the independent claims. Further preferred embodiments are given by the subject-matter of the dependent claims.

In particular, the design of a 3 degree-of-freedom (DoF) apparatus with only one actuator is discussed herein; the system further has a position control. This makes the weight of the main part of the system, also lowering its price, and making it a good choice for home rehabilitation. The abilities of the system have been tested showing that the apparatus has a good tracking ability and makes a user-friendly environment for the participants.

A modular wrist and forearm rehabilitation apparatus is proposed providing exercises for wrist and forearm rehabilitation. Consecutive rehabilitation of wrist and forearm may help the nerve of hand to revive faster and help the apoplexy patients. This system enables rehabilitation of all three relevant DOF with only one motor making the system light weight and reducing the costs. These features make the system a good choice for home or clinical rehabilitation. A quantitative evaluation supports that the system provides comfort and ease of use.

Further, this apparatus provides active resistance exercises which could make the rehabilitation process more effective and reduces the dependence to the therapist. This system could be used in the clinic as an assistant for the therapist or at home as a home rehabilitation apparatus. Some of the benefits of in-home therapy include convenience as there is no necessity to wait for an appointment, saving time as there is no need to commute to the medical facility, saving energy by reducing the commute, which is particularly advantageous for elderly and/or handicapped people recovering from surgery, and helping the therapists as it reliefs their burden.

Many patients receiving in-home therapy report regaining their independence quicker compared to outside therapy.

Machines make it comfortable for patients to repeat the motions without deviation from the desired path and patients are not worried to move farther than the trajectory. The safety of the exercises could be checked and due to knowing what motions are expected and the apparatus can be stopped each time the patients want, they feel the process controllable.

The ability to record the data is an opportunity that could be added to apparatuses allowing the physicians to analyze the results and finding new trends for the patients, thus improving the therapy over time, specifically for each patient.

According to an aspect of the present invention, there is provided a rehabilitation apparatus for wrist and forearm therapy comprising an adjustable armrest, a motor, and a rotatable base having a plurality of sockets for engaging a plurality of handles for different types of therapy, wherein the motor is configured to move the rotatable base.

### BRIEF DESCRIPTION OF THE DRAWINGS

Aspects of the present invention, which are presented for better understanding the inventive concepts but which are not to be seen as limiting the invention, will now be described with reference to the figures in which:

FIGS. 1A-1C show various schematic configurations of a rehabilitation apparatus for wrist and forearm therapy.

FIGS. 2A-2C show the three relevant degrees of freedom for wrist and forearm therapy.

FIGS. 3A-3C show the desired trajectory and the PID controller response for the three relevant degrees of freedom for wrist and forearm therapy.

FIG. 4 shows a possible configuration of a rehabilitation apparatus in a rehabilitation system including the patient and the rehabilitation apparatus transferring data and the medical personal receiving and processing the data.

FIG. 5 shows a schematic of the controlling processing.

### DETAILED DESCRIPTION

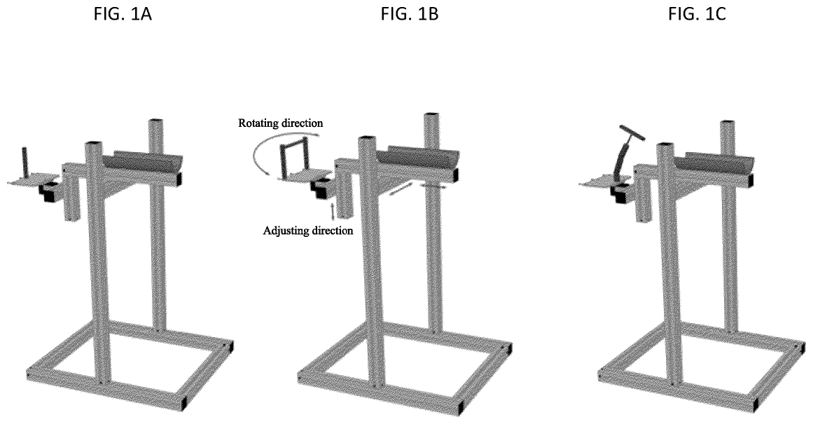

FIGS. 1A to 1C show various schematic configurations of a rehabilitation apparatus for wrist and forearm therapy. Common to all three figures is that the rehabilitation apparatus comprises an adjustable armrest, a motor, possibly a DC motor, and a rotatable base having a plurality of socket for engaging a plurality of handles for different types of therapy, wherein the motor is able to move the rotatable base.

In a possible implementation, the motor includes a gearbox with a ratio of 1:272.5 provides adequate torque output which is about 1.7 Nm for supination-pronation and 1.2 Nm for flexion-extension and ulnar-radial movements. Another safety feature that was predicted in the design is that the rotating plate collided with the forearm holder when the wrist bends more than adjustable safety limit based on patient's ability. So, the forearm holder acts as a mechanical stop which increases the safety of the system. Thus, the modular characteristic increases the application of the apparatus. The range of rotation for Pronation-supination is −71 to 86 degree, for ulnar-radial is −19 to 33 degree °, and −71 to 73 degree for flexion-extension [45] which are covered with this apparatus.

Further, the rehabilitation apparatus may comprise a motor holder. This allows the system to be adjustable in all three axes.

Further, the armrest may be adjusted to be used for the left hand or the right hand, further increasing the flexibility when using the rehabilitation apparatus.

Further, the height and the distance of the armrest with respect to the rotatable base may be adjustable. This removes any danger of the axes eccentric distance between flexion-extension and ulnar-radial by removing the changes of straining the hand while doing these exercises.

Further, the armrest may be adjustable to different sizes of the hand or forearm. This solves inconsistent situations, that is, ensures that the apparatus can be used flexible by different persons; it is adjustable for different patients and its flexibility is also useful for adjusting the place of each patient hand.

This system may be able to be regulated along forearm axis. The motor place may be set for distance between palm and the rotating plate. Also, the forearm may be moved to the desired coordinate according to each person.

The rehabilitation apparatus may be unsafe and uncomfortable if it has not a correct axis alignment. In this system an adaptive forearm holder is designed to compensate misalignments. When inconsistent axes exist, the forearm may have to move to adjust its place. However, the present rehabilitation apparatus provides an alignment mechanism for all relevant dimensions and further the links are adjustable.

FIG. 1A shows a rehabilitation apparatus in which the rotatable base is engaged with a handle for flexion-extension therapy of the wrist. In this case the handle may be a straight handle. The important aspect of such a handle is that the rotational movement of the rotatable base is transformed into a flexion-extension movement for the appropriate therapy.

FIG. 1B shows a rehabilitation apparatus in which the rotatable base is engaged with a handle for ulnar-radial therapy of the wrist. In this case the handle may be of the shape of an inverted U. The ends of the inverted U are engaged into the rotatable base while the horizontal bar of the U is the part gripped by the patient during therapy. The important aspect of such a handle is that the rotational movement of the rotatable base is transformed into an ulnar-radial movement for the appropriate therapy.

FIG. 1C shows a rehabilitation apparatus in which the rotatable base is engaged with a handle for supination-pronation therapy of the forearm. In this case the handle may be of T-shape with an additional bend towards the arm rest. The important aspect of such a handle is that the rotational movement of the rotatable base is transformed into a supination-pronation movement for the appropriate therapy.

Taken together, the rehabilitation apparatus may be engaged with a handle for a flexion-extension rotation of the wrist, a handle for an ulnar-radial extension movement of the wrist, or a handle for a supination-pronation extension movement of the forearm. Each of these handles transfers the rotational movement of the rotatable base into the correct rotational axis such that the different types of therapeutic movements can be performed.

From the above explanations, it is evident that the rotatable base allows the apparatus to be modular such that the different types of therapy can be realized in one apparatus with minimal effort of configuration resp. reconfiguration, that is, all three relevant degrees of freedom can be worked on with the apparatus. In particular, only one motor is used to actuate all three degrees of freedom. Thus a modular rehabilitation apparatus that can provide therapy for all three degrees of freedom relevant for hand/wrist injuries in one apparatus in a simple manner is provided.

Thus, the apparatus trains multiple DOFs and provides exercises for daily life. Also, it reduces the load on the physician and patient and does the exercises in a limited workspace. It has a simple and multipurpose design.

Further, the resulting apparatus has low weight and has a low cost, therefore is affordable for patients and a good choice for using as a home rehabilitation apparatus or as a tele-rehabilitation apparatus, that is, either by the patient alone or in cooperation with some medical personal.

In another aspect of the invention, the motor of rehabilitation apparatus moves the rotatable base according to a therapy mode, the therapy mode being at least one of: a passive mode, an active mode, and an active resistance mode.

The passive mode is a mode in which the handle moves the patient's hand or forearm and guides the patient through a set of motions. The active mode is a mode in which the patient does the movements actively without support by the rehabilitation apparatus. The active resistance mode is a mode in which the patient does the movements actively while the rehabilitation apparatus provides an external force in the direction reverse to the patient's movement.

The three different modes of therapy further improve the flexibility of uses of the apparatus.

Moreover, the rehabilitation apparatus may comprise an emergency key to execute an emergency stop as a safety measure. The emergency key may be realized by means of a software representation, an electrical representation, or a mechanical representation. The emergency key may be provided between a power supply and the apparatus to ensure the safety in operation.

Due to the fact that the system is not wearable, when the patient feels unsafe pressure, they can open their fist. The system has decoupled DOFs so it moves the forearm and wrist separately and it makes the control of the system simpler.

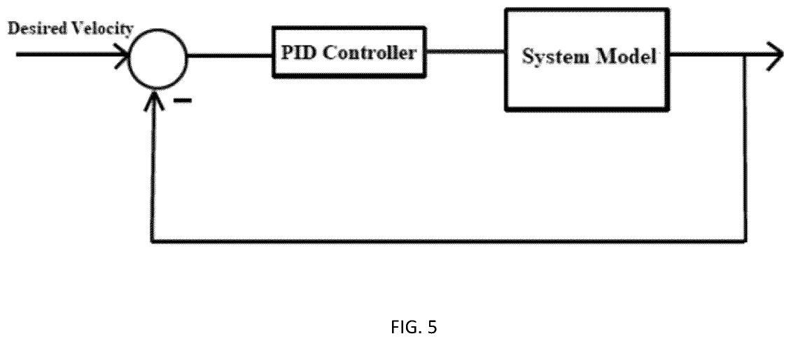

In another aspect of the invention, the rehabilitation apparatus further comprises a controller controlling the motor. The controller may be a digital positioning controller. The control system of the apparatus may communicate with an external computer via a D2U2 connection. An example of such a control process is depicted in FIG. 5. Therein, a PID controller is used for controlling the rehabilitation apparatus. In order to find the proper coefficients of the mathematical model of the system used in controlling the rehabilitation apparatus, model was firstly simulated. In this simulation, a desired velocity of the rotation was input and the system followed with an implemented angle restriction to ensure the safety of the patient. That is, the movement was restricted such that the angle with respect to the default position of the rotatable base being in the direct line of the arm rest is less than a predetermined threshold. The then measured velocity was fed back into the system to create a feedback loop.

Further, the controller may be capable of recording data, preferably position, velocity, current, force, and torque data.

This data may be at least one of: the data of the movement performed by the motor and the data of the movement performed by the rotatable base. Please note that in particular in the active resistance mode, the movement performed by the motor, that is, the force applied by the motor, and the movement of the handle, that is, the actual movement made by the patient against the force of the motor, are different. In particular in the case that both types of the data are recorded, the entire set of data provides a complete picture of the therapeutic exercise performed by the patient.

Further, this data may be used for analyzing a progress of a patient in rehabilitation. That means, based on the data recorded and in particular based on data recording for a plurality of therapeutic exercises during the entire duration of the therapy, the progress of a patient can be analyzed by comparing data from different exercises, by comparing the recorded data with expected values for said data, or the like.

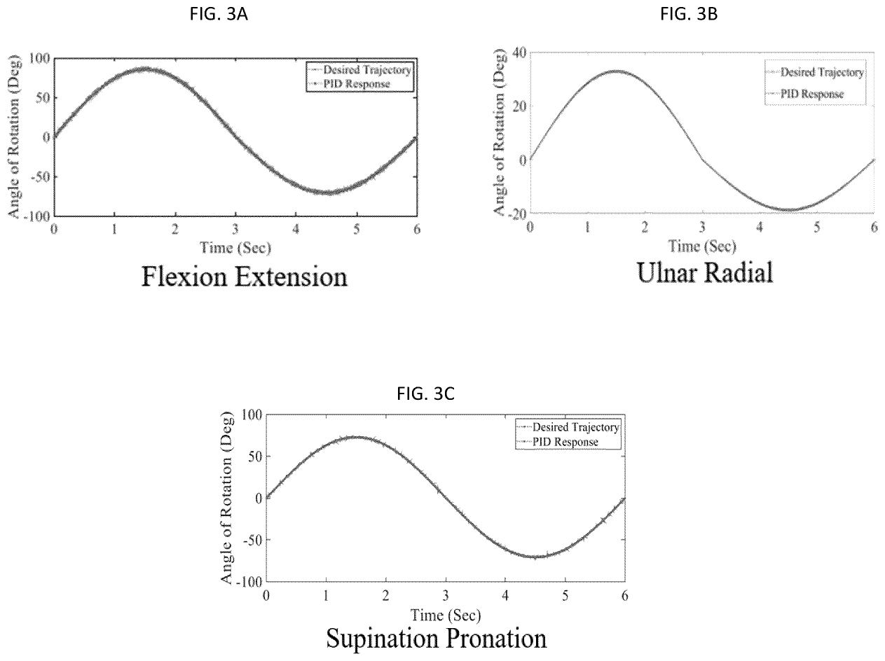

FIGS. 3A-3C show the desired trajectory and a controller response for the three relevant degrees of freedom for wrist and forearm therapy.

To evaluate the apparatus design for specific wrist and forearm trainings, trajectory tracking experiments were carried out for each DOF. As like as flexion-extension training, the ulnar-radial and supination-pronation exercises have been done on some participants with the designed PID controller. In the experiments, the desired paths for the wrist and forearm are defined as a sine path and the performances of the system with the PID controller have been found.

FIG. 3A shows the trajectory tracking graphs of the participants for flexion-extension, in which the blue item is the desired trajectory and the red one is the average trajectory tracking responses of the apparatus with participants.

FIG. 3B and FIG. 3C resp. show the experiments results for ulnar-radial and supination-pronation exercises, respectively. As can be seen, the PID controller can meet the expectations for following the desired path well.

Moreover, the controller may be capable of adjusting the motor control parameters according to a progress of a patient in rehabilitation. This may happen semi-instantaneous, that is, during the therapeutic session in which the data is recorded by means of artificial intelligence analyzing the data and adjusting the parameters during the session. Alternatively, the data may be transmitted to medical personal, such as a psychotherapist or a physician. Then, the medical personal may provide input for adjusting the control parameters and may provide guidance in form of comments to the patient regarding the progress of the rehabilitation.

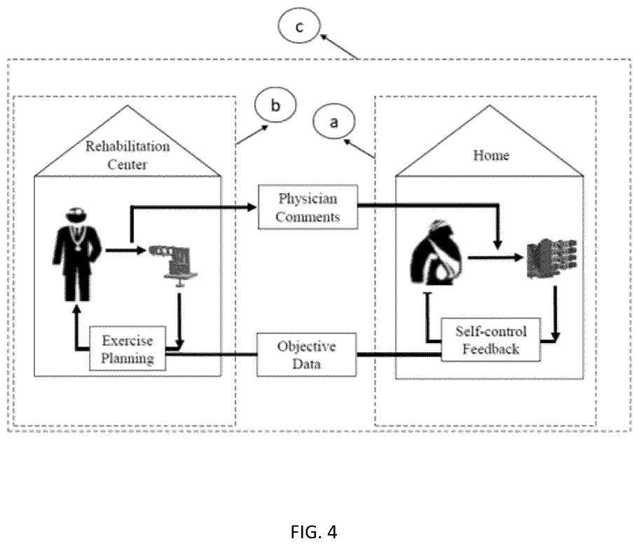

FIG. 4 shows a possible configuration of a rehabilitation apparatus in a rehabilitation system including the patient and the rehabilitation apparatus transferring data and the medical personal receiving and processing the data.

In detail, FIG. 4 shows on the left-hand side the patient at home that performs the therapy and thanks to the data recorded can perform self-control feedback. The right-hand side shows a medical facility such as a rehabilitation center in a medical personal receives the data recorded by the controller. Based on this data, the medical personal can adjust the therapy of the patient and can provide the patient with qualified medical feedback which in turn can improve the therapeutic progress.

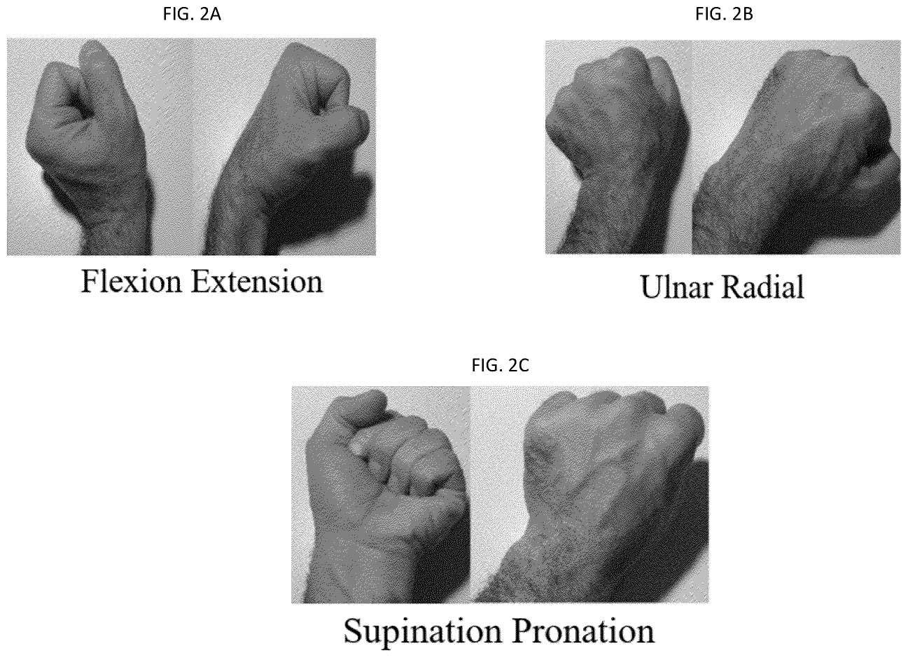

FIGS. 2A to 2C show the three relevant degrees of freedom for wrist and forearm therapy. FIG. 2A shows the flexion-extension movement of the wrist, that is, the bending and straightening. FIG. 2B shows the ulnar-radial movement of the wrist, that is, the movement towards and away from the midline of the body. FIG. 2C shows the supination-pronation movement of the forearm, that is, the inwards and outwards rotation of the forearm.

For making sure about the apparatus performance, a questionnaire was filled by participants. To make a comprehensive evaluation of the system, in the aspects of comfort, ease of use, level of user acceptance, etc., a questionnaire survey were designed for some healthy subjects. They accomplished the survey after the trainings. These feedbacks are obtained from the questionnaire. All participants stated that they had no confusion by using the apparatus and they understood the instructions very well. They are questioned about whether it was comfortable during the trainings and 66% of them said that the fingers grasping and forearm place were ‘very comfortable’, without any pain, while 33% of participant scored as ‘good’ and said that it is almost big for women. When asked about the easiness of applying the apparatus, all participants said that it was ‘very easy’, and it was evident in the scores of each of them. This might be recognized for the straps that were easy to fix, while the reconfigurable mechanism were convenient for replacing. There was a general feeling that this assist apparatus in a scenario for rehabilitation was accepted and makes a user-friendly feeling for the participants.

Although detailed aspects have been described, these only serve to provide a better understanding of the invention defined by the independent claims and are not to be seen as limiting.

1. A rehabilitation apparatus for wrist and forearm therapy comprising:
an adjustable armrest,
a motor, and
a rotatable base having a plurality of sockets for engaging a plurality of handles for different types of therapy,
wherein the motor is configured to move the rotatable base.

2. The rehabilitation apparatus according to claim 1, wherein the handle is at least one of:
a handle for a flexion-extension rotation of the wrist, a handle for an ulnar-radial extension movement of the wrist, and a handle for a supination-pronation extension movement of the forearm.

3. The rehabilitation apparatus according to claim 1, further comprising a motor holder.

4. The rehabilitation apparatus according to claim 1, wherein the motor is configured to move the rotatable base according to a therapy mode.

5. The rehabilitation apparatus according to claim 3, wherein the therapy mode is at least one of: a passive mode, an active mode, and an active resistance mode.

6. The rehabilitation apparatus according to claim 1, wherein the armrest can be adjusted to be used for the left hand or the right hand.

7. The rehabilitation apparatus according to claim 1, wherein the height and the distance of the armrest with respect to the rotatable base can be adjusted.

8. The rehabilitation apparatus according to claim 1, wherein the armrest can be adjusted to different sizes of the hand or forearm.

9. The rehabilitation apparatus according to claim 1, further comprising an emergency key configured to execute an emergency stop.

10. The rehabilitation apparatus according to claim 9, wherein the emergency key is realized by means of a software representation, an electrical representation, or a mechanical representation.

11. The rehabilitation apparatus according to claim 1, further comprising a controller configured to control the motor.

12. The rehabilitation apparatus according to claim 11, further comprising a controller capable of recording data, preferably position, velocity, current, force, and torque data.

13. The rehabilitation apparatus according to claim 12, wherein the data is used for analyzing a progress of a patient in rehabilitation.

14. The rehabilitation apparatus according to claim 11, wherein the controller is capable of adjusting the motor control parameters according to a progress of a patient in rehabilitation.
